(19) United States
(12) Patent Application Publication
(10) Pub. No.: US 2006/0288063 A1
(43) Pub. Date: Dec. 21, 2006

(54) Method and system for high speed precoder design

(76) Inventor: Arthur Abnous, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/155,102

(22) Filed: Jun. 17, 2005

(51) Int. Cl. G06F 17/10

(52) U.S. Cl. 708/300

(57) ABSTRACT

Methods and systems for processing a signal are disclosed herein and may comprise adding a plurality of offsets to a summed input signal to generate a plurality of offset summed input signals. The offset summed input signals may be filtered to generate a plurality of filtered offset summed input signals. A plurality of summed current input signals may be generated by adding the plurality of filtered offset summed input signals to an input signal. While the summed current input signals are being generated, an offset is simultaneously determined for an output signal based on the summed input signal. The offsets may be added to the summed input signal via carry-save addition. The plurality of offsets may comprise a zero offset. The offset summed input signals may be filtered utilizing infinite impulse response filter and/or finite impulse response filter.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to processing of signals. More specifically, certain embodiments of the invention relate to a method and system for high speed precoder design.

### BACKGROUND OF THE INVENTION

High-speed digital communication networks over copper and optical fiber are used in many network communication and digital storage applications. Ethernet and Fiber Channel are two widely used communication protocols, which continue to evolve in response to increasing demands for higher bandwidth in digital communication systems. The Ethernet protocol may provide collision detection and carrier sensing in the physical layer. The physical layer, layer 1, is responsible for handling all electrical, optical, opto-electrical and mechanical requirements for interfacing to the communication media. Notably, the physical layer may facilitate the transfer of electrical signals representing an information bitstream. The physical layer (PHY) may also provide services such as, encoding, decoding, synchronization, clock data recovery, and transmission and reception of bit streams. Some PHY services may be provided by one or more Ethernet PHY transceivers.

As the demand for higher data rates and bandwidth continues to increase, equipment vendors are continuously being forced to employ new design techniques for manufacturing network equipment capable of handling these increased data rates. In response to this demand, physical layer (PHY) transceivers have been designed to operate at gigabit speeds to keep pace with this demand for higher data rates. Gigabit Ethernet, which initially found application in 10 GBASE-T servers, is becoming widespread in personal computers, laptops, and switches, thereby providing the necessary infrastructure for handling data traffic of PCs and packetized telephones. At gigabit speeds, timely processing of packetized data is central to the operation of a 10 GBASE-T transceiver. This is particularly true for sensitive traffic such as voice data. In this regard, 10 GBASE-T transceivers may be adapted to utilize one or more precoders prior to transmission and/or after reception of packetized data. A precoder may be utilized to transform an input signal and generate an output signal within a specific signal range. Conventional precoders, however, utilize signal conversions in the circuit critical signal path, or the longest signal processing path within the precoder. Signal format conversions within the circuit's critical path may significantly decrease the processing efficiency of the 10 GBASE-T (10 Gigabit Ethernet over copper) transceiver.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for high speed precoder design, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary precoder, which may be utilized in accordance with an embodiment of the invention.

FIG. 2 is a block diagram of an exemplary precoder with pre-computed offsets, in accordance with an embodiment of the invention.

FIG. 3 is a block diagram of an exemplary precoder with pre-computed offsets and a delayed output, in accordance with an embodiment of the invention.

FIG. 4 is a block diagram of an exemplary precoder, which may be utilized in accordance with an embodiment of the invention.

FIG. 5 is a flow diagram of exemplary steps for processing signals, in accordance with an embodiment of the invention.

### DETAILED DESCRIPTION OF THE INVENTION

Certain aspects of the invention may be found in a method and system for high speed precoder design. In one embodiment of the invention, an input signal and a plurality of offset signals may be filtered in a first operating cycle utilizing carry-save arithmetic. Simultaneously, in a second operating cycle, the input signal may be converted to binary form and an output signal may be selected from a plurality of offset signals calculated in a previous operation cycle. In this regard, by utilizing two simultaneous operating cycles with a single binary conversion, multiple signal conversions within the precoder's critical path from carry-save to binary format, for example, may be avoided. Accordingly, this results in increased signal processing efficiency of the precoder. Furthermore, by utilizing two simultaneous operating cycles rather than a single operating cycle utilized by conventional precoders, the precoder signal throughput may be approximately doubled.

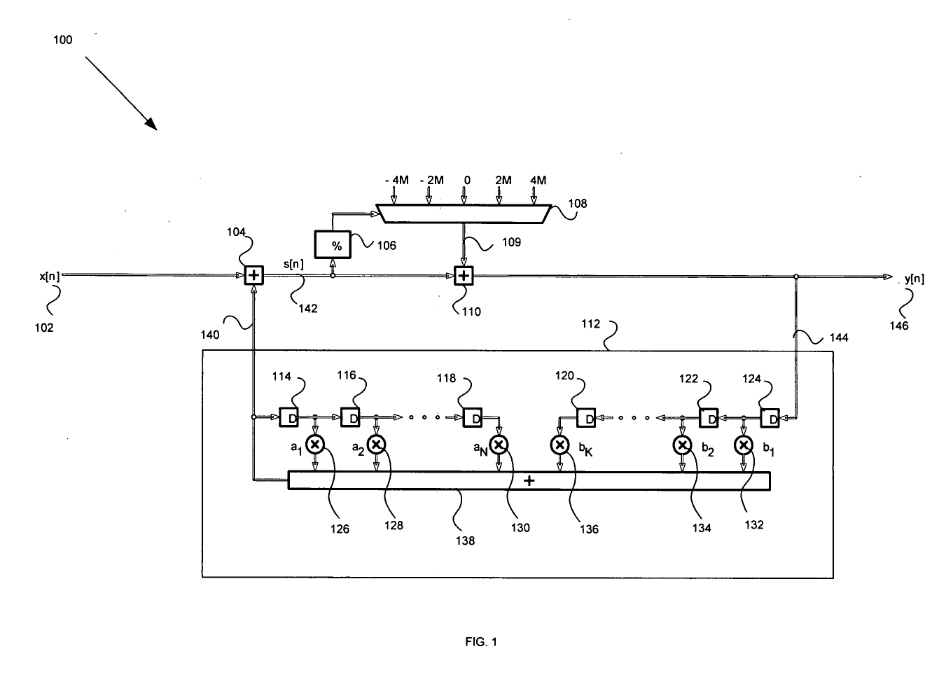

FIG. 1 is a block diagram of an exemplary precoder, which may be utilized in accordance with an embodiment of the invention. Referring to FIG. 1, the precoder 100 may comprise adders 104 and 110, a selector 106, a multiplexer 108, and a feedback filter 112. The feedback filter 112 may be an infinite impulse response (IIR) filter and may comprise delay blocks 114, . . . , 118 and 120, . . . , 124, adder 138, and multiplier blocks 132, . . . , 136 and 126, . . . , 130. The multiplier blocks 132, . . . , 136 may utilize multipliers b₁, . . . , bₖ, and multiplier blocks 126, . . . , 130 may utilize multipliers a₁, . . . , aₙ. Even though an IIR filter is illustrated in FIG. 1, the present invention may not be so limited and another type of filter, such as a finite impulse response (FIR) filter may be also utilized for filtering a feedback signal.

The adders 104, 110, and 138 may comprise suitable circuitry, logic, and/or code and may be adapted to add one or more signals and generate an output added signal. The multiplexer 108 may comprise suitable circuitry, logic, and/or code and may be adapted to select an output signal from a plurality of input signals. The delay blocks 1.20, . . . , 124 and 114, . . . , 118 may comprise suitable circuitry, logic, and/or code and may be adapted to delay an input signal by one operating cycle, for example. The multiplier blocks 132, . . . , 136 and 126, . . . , 130 may comprise suitable circuitry, logic, and/or code and may be adapted to multiply an input signal by a multiplier to generate a multiplied input.

The selector 106 may comprise suitable circuitry, logic, and/or code and may be adapted to acquire an input signal and determine a signal offset for the input signal. The signal offset may be selected so that an offset input signal utilizing the determined offset may be within a desired range, such as [−M; M]. In one embodiment of the invention, the selector 106 may be adapted to convert the input signal into binary form prior to an offset determination.

In operating, an input signal 102 may be received by the precoder 100 and may be communicated to the adder 104. The adder 104 may add the input signal 102 with an output signal 140 of the feedback filter 112 to generate an added signal 142. The output signal 140 may be generated by filtering a precoder output signal 144 from a previous operation cycle. For example, the precoder output signal 144 may be delayed by delay block 124 and then multiplied by multiplier block 132. The signal delayed by the delay block 124 may be subsequently delayed by delay block 122 and multiplied by multiplier block 134. The signal delay and multiplication process may continue for k number of times for example, utilizing a total of k number of delay blocks and k number of multiplier blocks. The signal delayed by the (k−1) delay block may be delayed by delay block 120 and multiplied by the multiplier block 136. Similarly, n number of delay blocks 114, . . . , 118 and n number of multiplier blocks 126, . . . , 130 may be utilized to process a feedback signal of the filter output signal 140 generated by the adder 138. The adder 138 may then add the resulting (k+n) multiplied signals to generate the filter output signal 140.

The added signal 142 may then be communicated to the selector 106. The selector 106 may convert the added signal 142 into binary form and may determine an offset so that a resulting offset signal utilizing the determined offset may be within a desired range, such as [−M; M]. In this regard, the precoder 100 may utilize a plurality of offsets, such as [−4M; −2M; −M; 0; M; 2M; 4M]. An offset of 0-may-be selected when the added signal 142 is already within the desired range [−M; M]. If the added signal 142 is lower than −M, an offset greater than 0 may be selected, and if the added signal 142 is higher than −M, an offset lower than 0 may be selected. Even though the precoder 100 utilizes a set of five offset values, the present invention is not so limited. In another embodiment of the invention, a different number of offsets may be utilized to offset an added input signal.

After the selector 106 selects the offset, the determined signal offset may be communicated to the multiplexer 108. The multiplexer 108 may select the determined offset and may communicate the selected offset 109 to the adder 110. The adder 110 may add the selected offset 109 to the added signal 142 to generate the output signal 146.

In an exemplary operating cycle, the critical signal path within the precoder 100 may start with the first delay block 124 of the feedback filter 112 and may continue through the remaining delay and multiply blocks, the adder 138, the input adder 104, the selector 106, the multiplexer 108, and the adder 110. In one embodiment of the invention, the processing speed within the precoder 100 may be improved by utilizing carry-save arithmetic to perform the multiplication and addition operations within the feedback filter 112, as well as the addition operations within the adders 104 and 110. However, the selector 106 may be adapted to convert the input signal into binary format in order to determine the corresponding offset, which may result in decreased signal processing speed within the signal critical path of the precoder 100.

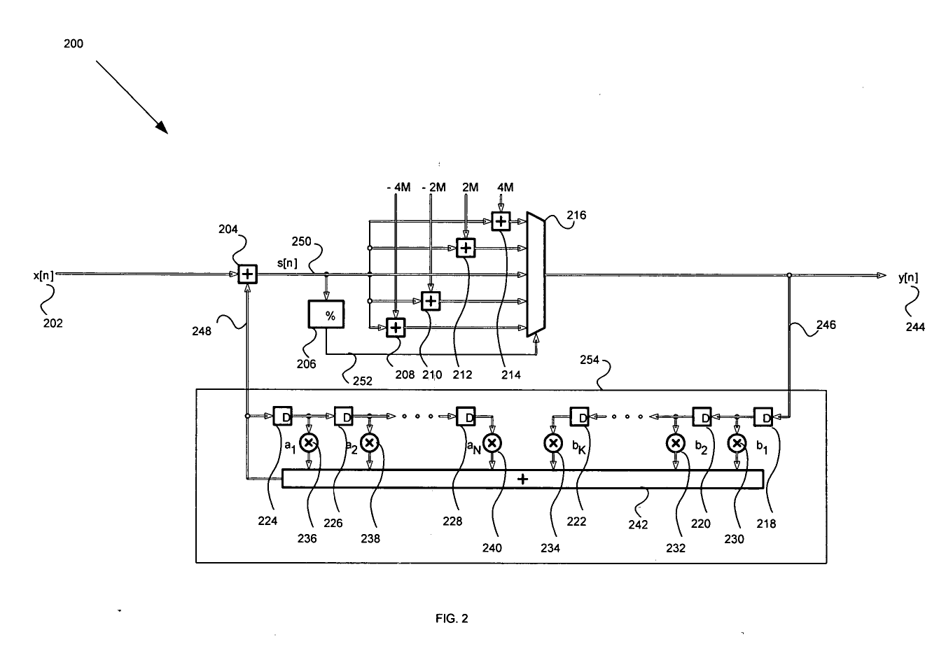

In another embodiment of the invention, processing speed and efficiency within a precoder may be increased by pre-computing a plurality of offset signals within a signal critical path, based on an input signal. FIG. 2 is a block diagram of an exemplary precoder with pre-computed offsets, in accordance with an embodiment of the invention. Referring to FIG. 2, the precoder 200 may comprise adders 204, and 208, . . . , 214, a selector 206, a multiplexer 216, and a feedback filter 254. The feedback filter 254 may be an infinite impulse response (IIR) filter and may comprise delay blocks 218, . . . , 222 and 224, . . . , 228, adder 242, and multiplier blocks 230, . . . , 234 and 236, . . . , 240. The multiplier blocks 230, . . . , 234 may utilize multipliers b₁, . . . , bₖ, and multiplier blocks 236, . . . , 240 may utilize multipliers a₁, . . . , aₙ. Even though an IIR filter is illustrated in FIG. 2, the present invention may not be so limited and another type of filter, such as a finite impulse response (FIR) filter may be also utilized for filtering a feedback signal.

An input signal 202 to the precoder 200 and an output signal 248 of the feedback filter 254 may be communicated as an input to the adder 204. An output of the adder 204 may be communicated as an input to the selector 206. Furthermore, the output 250 of the adder 204 may be communicated as an input to each of the adders 208, . . . , 214. The outputs of the adders 208, . . . , 214 may be communicated as inputs to the multiplexer 216. An output signal 252 of the selector 206 may be communicated to the multiplexer 216 for selecting a multiplexer output. The selected multiplexer output of the multiplexer 216 may be communicated as an input signal 246 to the feedback filter 254 and as an output signal 244. Within the feedback filter 254, the input signal 246 may be delayed by delay blocks 218, . . . , 222 and multiplied by multiplier blocks 230, . . . , 234. The delayed and multiplied signals may be summed by the adder 242. Furthermore, an output of the adder 242 may be delayed by delay blocks 224, . . . , 228 and multiplied by multiplier blocks 236, . . . , 240.

The adders 204, 242, and 208, . . . , 214 may comprise suitable circuitry, logic, and/or code and may be adapted to add one or more signals and generate an output added signal. The multiplexer 216 may comprise suitable circuitry, logic, and/or code and may be adapted to select an output signal from a plurality of input signals. The delay blocks 218, . . . , 222 and 224, . . . , 228 may comprise suitable circuitry, logic, and/or code and may be adapted to delay an input signal by one operation cycle, for example. The multiplier blocks 230, . . . , 234 and 236, . . . , 240 may comprise suitable circuitry, logic, and/or code and may be adapted to multiply an input signal by a multiplier to generate a multiplied input.

The selector 206 may comprise suitable circuitry, logic, and/or code and may be adapted to acquire an input signal and determine a signal offset for the input signal. The signal offset may be selected so that an offset input signal utilizing the determined offset may be within a desired range, such as [−M; M]. In one embodiment of the invention, the selector 206 may be adapted to convert the input signal into binary form prior to an offset determination.

In operation, the precoder 200 may be adapted to pre-compute a plurality of offset signals within a signal critical path, based on a single input signal and utilizing carry-save arithmetic. An input signal 202 may be received by the precoder 200 and may be communicated to the adder 204. The adder 204 may add the input signal 202 with an output signal 248 of the feedback filter 254 to generate an added signal 250. The output signal 248 may be generated by filtering a precoder output signal 246 from a previous operation cycle. For example, the precoder output signal 246 may be delayed by delay block 218 and then multiplied by multiplier block 230. The signal delay and multiplication process may continue for k number of times, for example, utilizing a total of k number of delay blocks 218, . . . , 222 and k number of multiplier blocks 230, . . . , 234. The signal delayed by the (k−1) delay block may be delayed by delay block 222 and multiplied by the multiplier block 234. Similarly, an n number of delay blocks 224, . . . , 228 and n number of multiplier blocks 236, . . . , 240 may be utilized to process a feedback signal of the filter output signal 248 generated by the adder 242. The adder 242 may then add the resulting (k+n) multiplied signals to generate the filter output signal 248. In each operation cycle, a filter output signal 248 may be generated from a precoder output signal 246 generated in a previous cycle.

The added signal 250 may then be communicated to the selector 206. The selector 206 may convert the added signal 250 into binary form and may determine an offset so that a resulting offset signal utilizing the determined offset may be within a desired range, such as [−M; M]. In this regard, the precoder 200 may utilize a plurality of offsets, such as [−4M; −2M; −M; 0; M; 2M; 4M]. An offset of 0 may be selected when the added signal 142 is already within the desired range [−M; M]. If the added signal 250 is lower than −M, an offset greater than 0 may be selected, and if the added signal 250 is higher than −M, an offset lower than 0 may be selected. After the selector 206 selects the offset, the determined signal offset 252 may be communicated to the multiplexer 216.

Simultaneously with the determination of the offset by the selector 206, the added signal 250 may be utilized by the adders 208, . . . , 214 to pre-calculate a plurality of offset signals utilizing a plurality of offsets. For example, offsets −4M, −2M, 2M, and 4M may be added to the added signal 250 by the adders 208, 210, 212, and 214, respectively, to generate the plurality of offset signals. The offset signals may be communicated to the multiplexer 216. The multiplexer 216 may select a precoder output signal 244 from the plurality of pre-calculated offset signals based on the offset 252 determined by the selector 206.

In an exemplary operation cycle, the critical signal path within the precoder 200 may start with the first delay block 218 of the feedback filter 254 and may continue through all remaining delay and multiply blocks within the filter 254, the adder 242, the input adder 204, one of the adders 208, . . . , 214, and the multiplexer 108. In this regard, processing efficiency within the precoder 200 is increased by pre-calculating a plurality of offset signals based on a single input signal utilizing carry-save arithmetic, rather than binary format arithmetic. In addition, binary format conversion by the selector 206 may be performed simultaneously with pre-calculation of the signal offsets, thereby further increasing processing efficiency within the precoder 200.

In one embodiment of the invention, the precoder 200 may utilize the pre-computed plurality of offset signals to also pre-compute a plurality of filtered offset signals within the feedback filter 254 utilizing carry-save arithmetic. In this regard, the pre-calculated filtered signals may be utilized by the precoder 200 during calculation of a subsequent output signal, for example, which may further decrease signal processing time within the precoder 200.

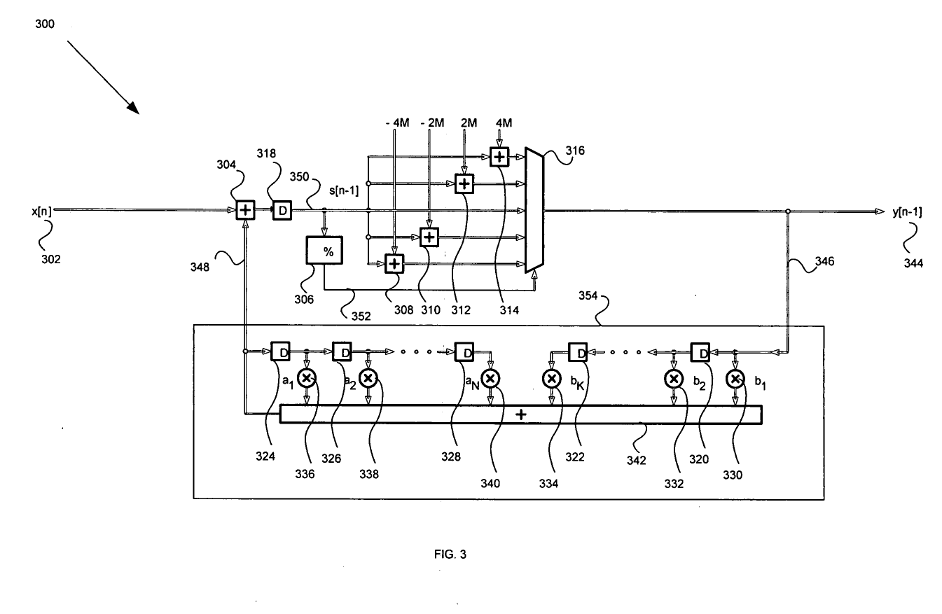

FIG. 3 is a block diagram of an exemplary precoder with pre-computed offsets and a delayed output, in accordance with an embodiment of the invention. Referring to FIG. 3, the precoder 300 may comprise adders 304, and 308, . . . , 314, a selector 306, a multiplexer 316, a delay block 318, and a feedback filter 354. The feedback filter 354 may be an infinite impulse response (IIR) filter and may comprise delay blocks 320, . . . , 322 and 324, . . . , 328, adder 342, and multiplier blocks 330, . . . , 334 and 336, . . . , 340. The multiplier blocks 330, . . . , 334 may utilize multipliers b₁, . . . , bₖ, and multiplier blocks 336, . . . , 340 may utilize multipliers a₁, . . . , aₙ. Even though an IIR filter is illustrated in FIG. 3, the present invention may not be so limited and another type of filter, such as a finite impulse response (FIR) filter may be also utilized for filtering a feedback signal.

The adders 304, 342, and 308, . . . , 314 may comprise suitable circuitry, logic, and/or code and may be adapted to add one or more signals and generate an output added signal. The multiplexer 316 may comprise suitable circuitry, logic, and/or code and may be adapted to select an output signal from a plurality of input signals. The delay blocks 318, . . . , 328 may comprise suitable circuitry, logic, and/or code and may be adapted to delay an input signal by one operation cycle, for example. The multiplier blocks 330, . . . , 340 may comprise suitable circuitry, logic, and/or code and may be adapted to multiply an input signal by a multiplier to generate a multiplied input.

Referring to FIGS. 2 and 3, the precoder 200 may be modified to obtain precoder 300 by moving the delay block 218 from the feedback filter 254 to a location within a signal path comprising the initial signal adder 304. For example, a first delay block within the filter 354 may be utilized as a delay block 318. The delay block 318 may be adapted to delay the output of the initial signal adder 304. In this regard, a previously filtered signal 348, generated by the feedback filter 354, may be utilized to generate the current delayed output signal 344.

The selector 306 may comprise suitable circuitry, logic, and/or code and may be adapted to acquire an input signal and determine a signal offset for the input signal. The signal offset may be selected so that an offset input signal utilizing the determined offset may be within a desired range, such as [−M; M]. In one embodiment of the invention, the selector 306 may be adapted to convert the input signal into binary form prior to an offset determination.

In one embodiment of the invention, the precoder 300 may be similar in operation to the precoder 200 of FIG. 2. However, a single delay block, such as the delay block 318 may be removed from the feedback filter 354 and may be placed after the input adder 304. In this regard, an input added signal generated by the input adder 304 may be delayed by one operating cycle, thereby generating delayed added signal 350. Furthermore, a delayed output signal 344 may be generated based on the delayed added input signal 350 and the pre-calculated offset signals generated by the adders 308, . . . , 314. By removing the delay block 318 from the feedback filter 354 and inserting it within the signal critical path after the input adder 304, the selector 306 may be given a full operation cycle to perform conversion of the input signal to binary and determining an offset.

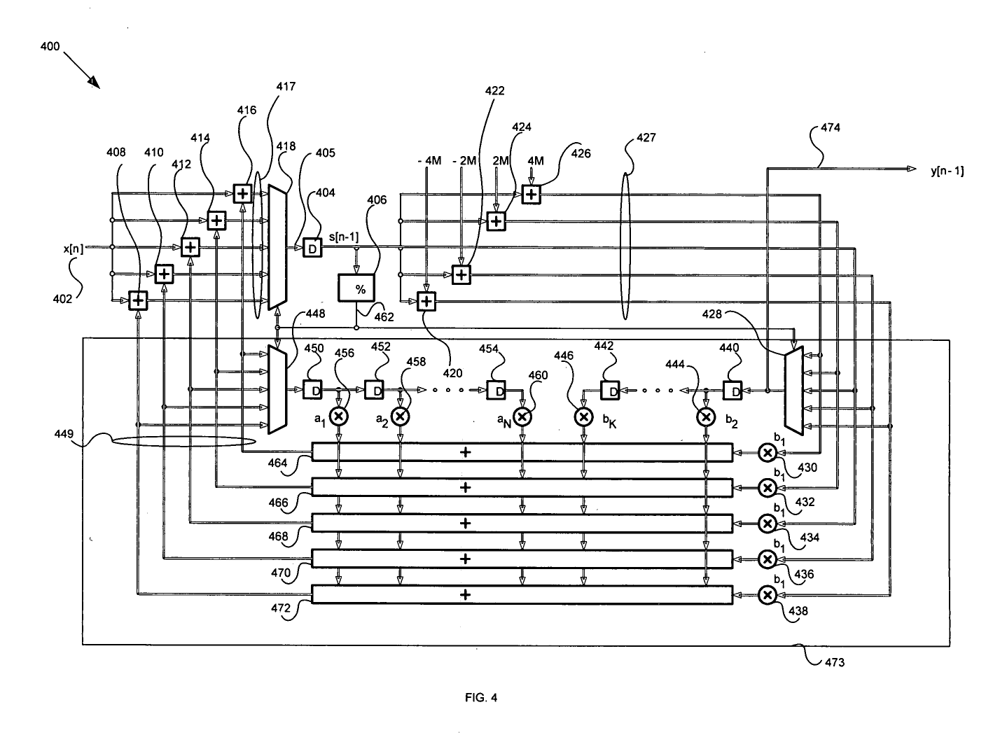

FIG. 4 is a block diagram of an exemplary precoder, which may be utilized in accordance with an embodiment of the invention. Referring to FIG. 4, the precoder 400 may comprise adders 408, . . . , 416, and 420, . . . , 426, a selector 406, a delay block 404, a multiplexer 418, and a feedback filter 473. The feedback filter 473 may be an infinite impulse response (IIR) filter and may comprise delay blocks 440, . . . , 442, and 450, . . . , 454, adders 464, . . . , 472, multiplier blocks 430, . . . , 438, 444, . . . , 446, and 456, . . . , 460, and multiplexers 448 and 428. The multiplier blocks 430, . . . , 438 may utilize multipliers b₁, multiplier blocks 444, . . . , 446 may utilize multipliers b₂, . . . , bₖ, and multiplier blocks 456, . . . , 460 may utilize multipliers a₁, . . . , aₙ. Even though an IIR filter is illustrated in FIG. 4, the present invention may not be so limited and another type of filter, such as a finite impulse response (FIR) filter may be also utilized for filtering a feedback signal.

An input signal 402 to the precoder 400 and output signals 449 of the feedback filter 473 may be communicated as inputs to the adders 408, . . . , 416. The outputs of the adders 408, . . . , 416 may be coupled as inputs to the multiplexer 418. The output of the multiplexer 418 may be coupled to an input of the delay block 404. The output of the delay block 404 may be coupled to an input of the selector 406, as well as to inputs of the adders 420, . . . , 426. The output of the selector 406 may be coupled to the multiplexers 428, 448, and 418. The outputs of the adders 420, . . . , 426 may be coupled as inputs to the filter 473. Within the feedback filter 473, the inputs to the filter 473 may be coupled to the inputs of the multiplexer 428 and to the multiplier blocks 430, . . . , 438. The output of the multiplexer 428 may be communicated as precoder output 474 and may be also delayed by delay blocks 440, . . . , 442. The delayed signal may-be multiplied by the multiplier blocks 444, . . . , 446 and added by the adders 464, . . . , 472. Furthermore, the outputs 449 of the adders 464, . . . , 472 may be coupled to the inputs of the multiplexer 448. The output of the multiplexer 448 may be coupled to the delay blocks 450, . . . , 454 and the multiplier blocks 456, . . . , 458.

The adders 408, . . . , 416, 420, . . . , 426, and 464, 472 may comprise suitable circuitry, logic, and/or code and may be adapted to add one or more signals and generate an output added signal. The multiplexers 418, 428, and 448 may comprise suitable circuitry, logic, and/or code and may be adapted to select an output signal from a plurality of input signals. The delay blocks 404, 440, . . . , 442, and 450, . . . , 454 may comprise suitable circuitry, logic, and/or code and may be adapted to delay an input signal by one operating cycle, for example. The multiplier blocks 430, . . . , 438, 444, . . . , 446, and 456, . . . , 460 may comprise suitable circuitry, logic, and/or code and may be adapted to multiply an input signal by a multiplier to generate a multiplied input.

The selector 406 may comprise suitable circuitry, logic, and/or code and may be adapted to acquire an input signal and determine a signal offset for the acquired input signal. The signal offset may be selected so that an offset input signal utilizing the determined offset may be within a desired range, such as [−M; M]. In one embodiment of the invention, the selector 406 may be adapted to convert the input signal into binary form prior to an offset determination.

In operation, the precoder 400 may be adapted to pre-compute a plurality of offset signals 417, and possible signal outputs 427, within a signal critical path, utilizing a single input signal 402 and a plurality of pre-calculated filtered signals from a previous operating cycle 449. The critical signal path within the precoder 400 may comprise the delay block 404, the adders 420, . . . , 426, the multiplier blocks 430, . . . , 438, the adders 464, . . . , 472, the adders408, . . . , 416, and the multiplexer 418. Simultaneously to the pre-calculation operation, a selector may be utilized to convert an added signal input into binary form and determine an offset selection corresponding to the added signal input. A precoder output 474 may then be selected from the pre-calculated offset signals communicated to the multiplexer 428 utilizing the determined desired offset 462.

A summed input signal 405, which is generated based on an input signal 402, may be delayed by the delay block 404. The delayed summed input signal may be communicated to the selector 406. The selector 406 may convert the delayed summed input signal into binary form and may determine an offset so that a resulting offset signal utilizing the determined offset may be within a desired range, such as [−M; M]. In this regard, the precoder 400 may utilize a plurality of offsets, such as [−4M; −2M; −M; 0; M; 2M; 4M]. An offset of 0 may be selected when the delayed summed input signal is already within the desired range [−M; M]. If the delayed summed input signal is lower than −M, an offset greater than 0 may be selected, and if the delayed summed input signal is higher than −M, an offset lower than 0 may be selected. After the selector 206 selects the offset, the determined signal offset 462 may be communicated to the multiplexers 428, 448, and 418.

Referring to FIGS. 3 and 4, the precoder 300 may be further enhanced by including additional multiplier blocks 432, . . . , 438, adders 408, . . . , 416, 466, . . . , 472, and multiplexers 418 and 448 to pre-compute a plurality of offset signals 417, and possible signal outputs 427, within a signal critical path, utilizing a single input signal 402 and a plurality of pre-calculated filtered signals from a previous operating cycle 449.

Simultaneously to the determination of the offset 462 by the selector 406, the delayed summed input signal may be utilized by the adders 420, . . . , 426 for pre-calculation of a plurality of a plurality of offset summed input signals 427 utilizing a plurality of offsets. For example, offsets −4M, −2M, 2M, and 4M may be added to the delayed summed input signal by the adders 420, 422, 424, and 426, respectively, to generate the plurality of offset summed input signals 427. The plurality of offset summed input signals 427 may be communicated to the multiplexer 428 within the filter 473, as well as to the multipliers 430, . . . , 438. At the time the desired offset 462 is generated, the multiplexer 428 may select a precoder delayed output signal 474 from the plurality of offset summed input signals 427 based on the offset 462 determined by the selector 406. Furthermore, the desired offset 462 may be also communicated to the multiplexers 418 and 448 for selection of a filtered offset summed input signal from the filter output signals 449 and a corresponding selection of a summed current input signal from the plurality of summed current input signals 417. The selected summed current input signal from the plurality of summed current input signals 417 may be delayed by the delay block 404 and may be utilized to generate a delayed precoder output signal for a subsequent operating cycle.

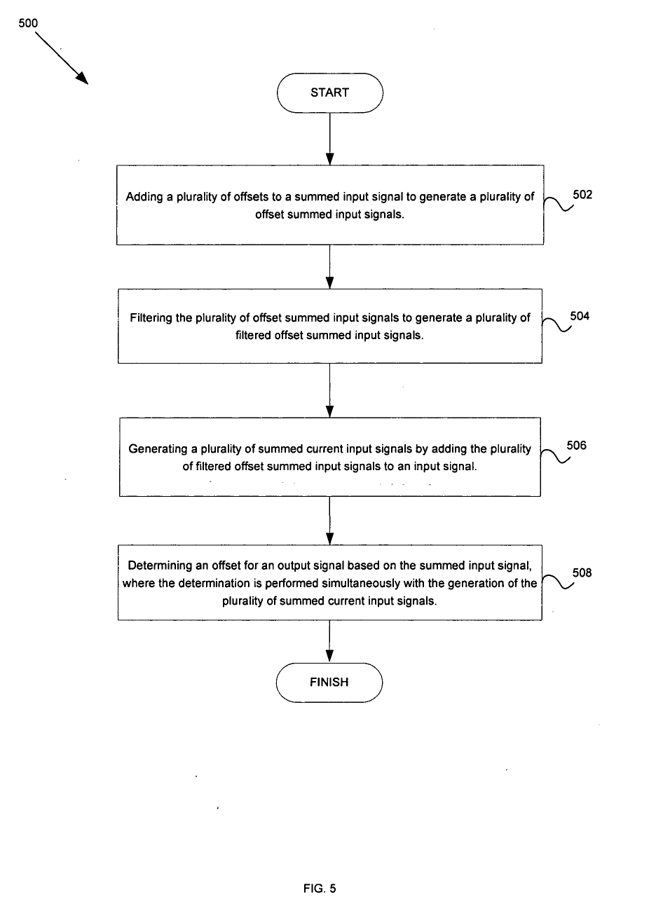

FIG. 5 is a flow diagram of exemplary steps for processing signals, in accordance with an embodiment of the invention. Referring to FIG. 5, at 502, a plurality of offsets may be added to a summed input signal to generate a plurality of offset summed input signals. At 504, the plurality of offset summed input signals may be filtered to generate a plurality of filtered offset summed input signals. At 506, a plurality of summed current input signals may be generated by adding the plurality of filtered offset summed input signals to an input signal. At 508, an offset may be determined for an output signal based on the summed input signal. The determination may be performed simultaneously with the generation of the plurality of summed current input signals.

Referring again to FIG. 4, a plurality of offsets may be added by the adders 420, . . . , 426 to a delayed summed input signal to generate a plurality of offset summed input signals 427. The plurality of offset summed input signals 427 may be filtered to generate a plurality of filtered offset summed input signals 449. A plurality of summed current input signals 417 may be generated by adding the plurality of filtered offset summed input signals 449 to an input signal 402. The plurality of filtered offset summed input signals 449 may be added to the input signal 402 via the adders 408, . . . , 416. The summed current input signals 417 may be communicated to the multiplexer 418 and a summed input signal 405 may be selected by the multiplexer 418 when the signal offset 462 is determined by the selector 406. Simultaneously with the determination of the plurality of summed current input signals 417, the selector 406 may determine the signal offset 462 for an output signal based on the summed input signal 405.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing a signal, the method comprising:
adding a plurality of offsets to a summed input signal to generate a plurality of summed offset input signals;
filtering said plurality of summed offset input signals to generate a plurality of filtered and summed offset input signals;
generating a plurality of summed current input signals by adding said plurality of filtered and summed offset input signals to an input signal; and
simultaneously with said generating, determining an offset for an output signal based on said summed input signal.

2. The method according to claim 1, further comprising adding said plurality of offsets to said summed input signal via carry-save addition.

3. The method according to claim 1, wherein said plurality of offsets comprise a zero offset.

4. The method according to claim 1, further comprising filtering said plurality of summed offset input signals utilizing at least one of: an infinite impulse response (IIR) filter and a finite impulse response (FIR) filter.

5. The method according to claim 1, further comprising adding said plurality of filtered and summed offset input signals to said input signal via carry-save addition.

6. The method according to claim 1, wherein said summed input signal comprises a delayed summed input signal.

7. The method according to claim 1, further comprising converting said summed input signal into a binary form to generate a binary summed input signal.

8. The method according to claim 7, further comprising determining said offset for said output signal based on said generated binary summed input signal.

9. The method according to claim 8, further comprising selecting said output signal from said plurality of summed offset input signals based on said determined offset.

10. The method according to claim 9, further comprising selecting a subsequent summed input signal from said plurality of summed current input signals based on said selection of said output signal, wherein said selection of said subsequent summed input signal is performed simultaneously with said selection of said output signal.

11. A system for processing a signal, the system comprising:
circuitry for adding a plurality of offsets to a summed input signal to generate a plurality of summed offset input signals;
circuitry for filtering said plurality of summed offset input signals to generate a plurality of filtered and summed offset input signals;
circuitry for generating a plurality of summed current input signals by adding said plurality of filtered and summed offset input signals to an input-signal; and
circuitry for simultaneously determining an offset for an output signal based on said summed input signal while said circuitry generates said plurality of summed current input signals.

12. The system according to claim 11, wherein said circuitry for adding adds said plurality of offsets to said summed input signal via carry-save addition.

13. The system according to claim 11, wherein said plurality of offsets comprise a zero offset.

14. The system according to claim 11, wherein said circuitry for filtering filters said plurality of summed offset input signals utilizing at least one of: an infinite impulse response (IIR) filter and a finite impulse response (FIR) filter.

15. The system according to claim 11, wherein said circuitry for generating said plurality of summer current input signals adds said plurality of filtered and summed offset input signals to said input signal via carry-save addition.

16. The system according to claim 11, wherein said summed input signal comprises a delayed summed input signal.

17. The system according to claim 11, further comprising circuitry for converting said summed input signal into a binary form to generate a binary summed input signal.

18. The system according to claim 17, wherein said circuitry for determining determines said offset for said output signal based on said generated binary summed input signal.

19. The system according to claim 18, further comprising circuitry for selecting said output signal from said plurality of summed offset input signals based on said determined offset.

20. The system according to claim 9, further comprising circuitry for selecting a subsequent summed input signal from said plurality of summed current input signals based on said selection of said output signal, wherein said selection of said subsequent summed input signal is performed simultaneously with said selection of said output signal.
